(19) United States
(12) Patent Application Publication
(10) Pub. No.: US 2026/0212158 A1
(43) Pub. Date: Jul. 23, 2026

(54) INTENT TAGS FOR GUIDING CONTENT GENERATION

(71) Applicant: Microsoft Technology Licensing, LLC, Redmond, WA (US)

(72) Inventors: Nathalie M. RICHE, Issaquah, WA (US); David William BROWN, Kirkland, WA (US); Hugo ROMAT, Seattle, WA (US); Michel PAHUD, Kirkland (WA); Nicolai MARQUARDT, Sammamish, WA (US); Michael J. BENTLEY, Bellevue, WA (US); Kenneth P. HINCKLEY, Kirkland, WA (US); Frederic Otto GMEINER, Pittsburgh, PA (US)

(73) Assignee: Microsoft Technology Licensing, LLC, Redmond, WA (US)

(21) Appl. No.: 19/032,742

(22) Filed: Jan. 21, 2025

(51) Int. Cl. G06N 3/0455; G06F 3/0482; G06F 3/04845; G06T 11/60

(52) U.S. Cl. CPC G06N 3/0455; G06F 3/0482; G06F 3/04845; G06T 11/60; G06T 2200/24

(57) ABSTRACT

This document relates to generative machine learning. Users can provide input relating to a content generation task. A generative machine learning model can be prompted to suggest concept tags based on the received user input. Then, users can select a concept tag and a value for that concept tag. A content item can be generated for the user using the generative machine learning model, where the content generation is based on the value for the selected concept tag. Over time, additional content tags can be updated with user-designated values while updating the generated content accordingly. In this manner, user generation of content with a generative machine learning model can be guided via received user inputs.

### BACKGROUND

In recent years, generative machine learning models have demonstrated tremendous capability at generating content. For instance, generative language models can generate text to summarize existing documents, help users draft new documents, and conduct natural language conversations with users at a very high level. As another example, generative image models can generate realistic and/or aesthetically-pleasing images from language prompts, and they can also modify existing images by restyling them and/or adding objects. However, generative machine learning models face certain obstacles to widespread adoption.

### SUMMARY

This Summary is provided to introduce a selection of concepts in a simplified form. These concepts are further described below in the Detailed Description. This Summary is not intended to identify key features or essential features of the claimed subject matter, nor is it intended to be used to limit the scope of the claimed subject matter.

The description generally relates to techniques for employing generative models to generate content for a user. One example includes a computer-implemented method that can include receiving user input relating to a content creation task involving generation of content including one or more content items. The method can also include, based at least on the user input, prompting a generative machine learning model to determine one or more suggested concept tags for the content creation task. The method can also include outputting the one or more suggested concept tags on a user interface. The method can also include receiving a selection of a selected concept tag from the one or more suggested concept tags via the user interface, the selected concept tag being associated with a selected property having multiple possible values. The method can also include receiving user input designating a particular value for the selected property associated with the selected concept tag. The method can also include prompting the generative machine learning model to generate a particular content item based at least on the particular value for the selected property. The method can also include outputting the particular content item generated by the generative machine learning model via the user interface.

Another example entails a system that includes a processor and a storage medium storing instructions. When executed by the processor, the instructions can cause the system to receive user input relating to a content creation task involving generation of content including one or more content items. The instructions can also cause the system to, based at least on the user input, prompt a generative machine learning model to determine one or more suggested concept tags for the content creation task. The instructions can also cause the system to output the one or more suggested concept tags on a user interface. The instructions can also cause the system to receive a selection of a selected concept tag from the one or more suggested concept tags via the user interface, the selected concept tag being associated with a selected property having multiple possible values. The instructions can also cause the system to receive user input designating a particular value for the selected property associated with the selected concept tag. The instructions can also cause the system to prompt the generative machine learning model to generate a particular content item based at least on the particular value for the selected property. The instructions can also cause the system to output the particular content item generated by the generative machine learning model via the user interface.

Another example includes a computer-readable storage medium storing executable instructions which, when executed by a processor, cause the processor to perform acts. The acts can include receiving user input relating to a content creation task involving generation of content including one or more content items. The acts can also include, based at least on the user input, prompting a generative machine learning model to determine one or more suggested concept tags for the content creation task. The acts can also include outputting the one or more suggested concept tags on a user interface. The acts can also include receiving a selection of a selected concept tag from the one or more suggested concept tags via the user interface, the selected concept tag being associated with a selected property having multiple possible values. The acts can also include receiving user input designating a particular value for the selected property associated with the selected concept tag. The acts can also include prompting the generative machine learning model to generate a particular content item based at least on the particular value for the selected property. The acts can also include outputting the particular content item generated by the generative machine learning model via the user interface.

The above-listed examples are intended to provide a quick reference to aid the reader and are not intended to define the scope of the concepts described herein.

### BRIEF DESCRIPTION OF THE DRAWINGS

The Detailed Description is described with reference to the accompanying figures. In the figures, the left-most digit(s) of a reference number identifies the figure in which the reference number first appears. The use of similar reference numbers in different instances in the description and the figures may indicate similar or identical items.

FIG. 1 illustrates an example generative language model, consistent with some implementations of the present concepts.

FIG. 2 illustrates an example generative image model, consistent with some implementations of the present concepts.

FIG. 3 illustrates an example computer vision model, consistent with some implementations of the present concepts.

FIG. 4 illustrates an example vision language model, consistent with some implementations of the present concepts.

FIGS. 5A-5J, 6A, 6B, 7A-7C, and 8A-8D illustrate example graphical user interfaces, consistent with some implementations of the disclosed techniques.

FIG. 9 illustrates an example of a system in which the disclosed implementations can be performed, consistent with some implementations of the disclosed techniques.

FIG. 10 illustrates an example of a method consistent with some implementations of the present concepts.

### DETAILED DESCRIPTION

### Overview

As noted above, generative machine learning models offer tremendous capabilities for generation of content, such as images and text. However, techniques for facilitating user interaction with a generative machine learning model can have certain drawbacks. For instance, while users can manually draft one or more prompts that are then input directly to the generative machine learning model, many users lack sufficient sophistication and experience to draft effective prompts.

As one example, generative machine learning models can be employed for generating documents, such as slide decks, word processing documents, spreadsheets, etc. One way to employ a generative machine learning model to generate a document involves having the user input a description of the document that they want to generate, and then generating an initial draft of the document with a generative machine learning model. However, this is a very coarse approach that still often results in the user expending significant effort to manually revise the initially-generated draft document.

The disclosed implementations offer techniques for employing “intent tags” to allow users to guide content generation by a machine learning model. An “intent tag” can include a property of the generated content along with a value that specifies the user's intent with respect to that property. For instance, one intent tag could specify the user's intent for the length of a generated document, and another intent tag could specify the user's intent for the target audience of the generated document. By allowing users to iteratively specify and modify intent tags while guiding content generation according to the current values of the intent tags, the disclosed techniques provide a flexible approach to assisting users in generating and refining content using generative machine learning models.

### Machine Learning Overview

There are various types of machine learning frameworks that can be trained to perform a given task. Support vector machines, decision trees, and neural networks are just a few examples of machine learning frameworks that have been used in a wide variety of applications, such as image processing, computer vision, and natural language processing. Some machine learning frameworks, such as neural networks, use layers of nodes that perform specific operations.

In a neural network, nodes are connected to one another via one or more edges. A neural network can include an input layer, an output layer, and one or more intermediate layers. Individual nodes can process their respective inputs according to a predefined function, and provide an output to a subsequent layer, or, in some cases, a previous layer. The inputs to a given node can be multiplied by a corresponding weight value for an edge between the input and the node. In addition, nodes can have individual bias values that are also used to produce outputs. Various training procedures can be applied to learn the edge weights and/or bias values. The term “parameters” when used without a modifier is used herein to refer to learnable values such as edge weights and bias values that can be learned by training a machine learning model, such as a neural network.

A neural network structure can have different layers that perform different specific functions. For example, one or more layers of nodes can collectively perform a specific operation, such as pooling, encoding, or convolution operations. For the purposes of this document, the term “layer” refers to a group of nodes that share inputs and outputs, e.g., to or from external sources or other layers in the network. The term “operation” refers to a function that can be performed by one or more layers of nodes. The term “model structure” refers to an overall architecture of a layered model, including the number of layers, the connectivity of the layers, and the type of operations performed by individual layers. The term “neural network structure” refers to the model structure of a neural network. The term “trained model” and/or “tuned model” refers to a model structure together with parameters for the model structure that have been trained or tuned. Note that two trained models can share the same model structure and yet have different values for the parameters, e.g., if the two models are trained on different training data or if there are underlying stochastic processes in the training process.

There are many machine learning tasks for which there is a relative lack of training data. One broad approach to training a model with limited task-specific training data for a particular task involves “transfer learning.” In transfer learning, a model is first pretrained on another task for which significant training data is available, and then the model is tuned to the particular task using the task-specific training data.

The term “pretraining,” as used herein, refers to model training on a set of pretraining data to adjust model parameters in a manner that allows for subsequent tuning of those model parameters to adapt the model for one or more specific tasks. In some cases, the pretraining can involve a self-supervised learning process on unlabeled pretraining data, where a “self-supervised” learning process involves learning from the structure of pretraining examples, potentially in the absence of explicit (e.g., manually-provided) labels. Subsequent modification of model parameters obtained by pretraining is referred to herein as “tuning.” Tuning can be performed for one or more tasks using supervised learning from explicitly-labeled training data, in some cases using a different task for tuning than for pretraining.

### Terminology

The term “intent tag,” as used herein, refers to data representing an expression of user intent with respect to generation of content. For instance, intent tags can be populated based on user input to a graphical user interface using an input device (touchscreen, mouse, keyboard, etc.), voice, gestures, etc. One type of intent tag is a “concept tag,” which can include a property of generated content as well as a user-specified value for that property. Another type of intent tag is a “reference tag,” which provides a reference to a document that a user wishes to employ as context for content generation.

The term “generative model,” as used herein, refers to a machine learning model employed to generate new content. One type of generative model is a “generative language model,” which is a model that can generate new sequences of text given some input. One type of input for a generative language model is a natural language prompt, e.g., a query potentially with some additional context. For instance, a generative language model can be implemented as a neural network, e.g., a long short-term memory-based model, a decoder-based generative language model, etc. Examples of decoder-based generative language models include versions of models such as GPT, BLOOM, PaLM, Mistral, Gemini, and/or LLAMA. Generative language models can be trained to predict tokens in sequences of textual training data. When employed in inference mode, the output of a generative language model can include new sequences of text that the model generates.

Another type of generative model is a “generative image model,” which is a model that generates images or video. For instance, a generative image model can be implemented as a neural network, e.g., a generative image model such as one or more versions of Stable Diffusion, DALL-E, Sora, or GENIE. A generative image model can generate new image or video content using inputs such as a natural language prompt and/or an input image or video. One type of generative image model is a diffusion model, which can add noise to training images and then be trained to remove the added noise to recover the original training images. In inference mode, a diffusion model can generate new images by starting with a noisy image and removing the noise. Note also that generative image models can generate videos, and the term “image” also encompasses two-dimensional and three-dimensional video.

In some cases, a generative model can be multi-modal. For instance, a model may be capable of using various combinations of text, images, video, audio, application states, code, or other modalities as inputs and/or generating combinations of text, images, video, audio, application states, or code or other modalities as outputs. Here, the term “generative language model” encompasses multi-modal generative models where at least one mode of output includes natural language tokens. Likewise, the term “generative image model” encompasses multi-modal generative models where at least one mode of output includes images or video. Examples of multi-modal models include certain GPT variants such as GPT-40, Gemini, Chameleon, etc. Multi-modal models can also include lightweight models such as Phi-3-Vision-128K-Instruct.

In addition, some generative models can include computer vision capabilities. These models are capable of recognizing objects in input images. The term “computer vision model” encompasses multi-modal models such as one or more versions of CLIP (Contrastive Language-Image Pre-Training) and BLIP (Bootstrapping Language-Image Pre-Training). Note the term “computer vision model” also encompasses non-generative models, such as ResNet, Faster-RCNN, etc. The term “vision language model” refers to any multi-modal generative model that can generate text describing images or videos, including CLIP, BLIP, Vision-and-Language BERT, Flamingo, Chameleon, etc.

The term “prompt,” as used herein, refers to input provided to a generative model that the generative model uses to generate outputs. A prompt can be provided in various modalities, such as text, an image, audio, video, etc. The term “language generation prompt” refers to a prompt to a generative model where the requested output is in the form of natural language. The term “image generation prompt” refers to a prompt to a generative model where the requested output is in the form of an image. The term “suggested” refers to output predicted by a generative machine learning model, e.g., suggested tags, suggested values, and suggested images respectively refer to tags, values, and images predicted by a generative machine learning model.

The term “machine learning model” refers to any of a broad range of models that can learn to generate automated user input and/or application output by observing properties of past interactions between users and applications. For instance, a machine learning model could be a neural network, a support vector machine, a decision tree, a clustering algorithm, etc. In some cases, a machine learning model can be trained using labeled training data, a reward function, or other mechanisms, and in other cases, a machine learning model can learn by analyzing data without explicit labels or rewards.

### Example Decoder-Based Generative Language Model

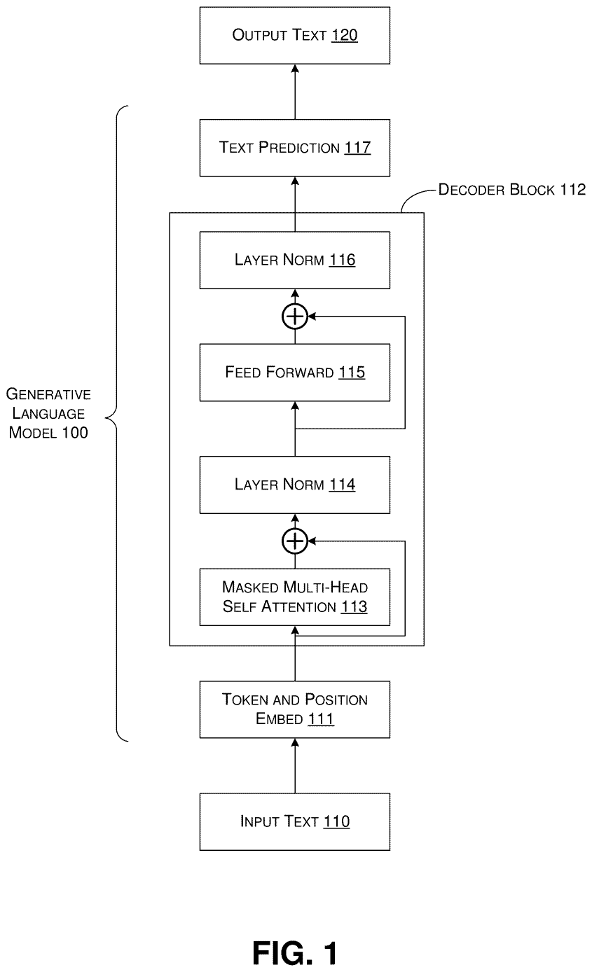

FIG. 1 illustrates an exemplary generative language model 100 (e.g., a transformer-based decoder) that can be employed using the disclosed implementations. (Radford, et al., “Improving language understanding by generative pre-training,” 2018). Generative language model 100 is an example of a machine learning model that can be used to perform one or more natural language processing tasks that involve generating text, as discussed more below. For the purposes of this document, the term “natural language” means language that is normally used by human beings for writing or conversation.

Generative language model 100 can receive input text 110, e.g., a prompt from a user or a prompt generated automatically by machine learning using the disclosed techniques. For instance, the input text can include words, sentences, phrases, or other representations of language. The input text can be broken into tokens and mapped to token and position embeddings 111 representing the input text. Token embeddings can be represented in a vector space where semantically-similar and/or syntactically-similar embeddings are relatively close to one another, and less semantically-similar or less syntactically-similar tokens are relatively further apart. Position embeddings represent the location of each token in order relative to the other tokens from the input text.

The token and position embeddings 111 are processed in one or more decoder blocks 112. Each decoder block implements masked multi-head self-attention 113, which is a mechanism relating different positions of tokens within the input text to compute the similarities between those tokens. Each token embedding is represented as a weighted sum of other tokens in the input text. Attention is only applied for already-decoded values, and future values are masked. Layer normalization 114 normalizes features to mean values of 0 and variance to 1, resulting in smooth gradients. Feed forward layer 115 transforms these features into a representation suitable for the next iteration of decoding, after which another layer normalization 116 is applied. Multiple instances of decoder blocks can operate sequentially on input text, with each subsequent decoder block operating on the output of a preceding decoder block. After the final decoding block, text prediction layer 117 can predict the next word in the sequence, which is output as output text 120 in response to the input text 110 and also fed back into the language model. The output text can be a newly-generated response to the prompt provided as input text to the generative language model.

Generative language model 100 can be trained using techniques such as next-token prediction or masked language modeling on a large, diverse corpus of documents. For instance, the text prediction layer 117 can predict the next token in a given document, and parameters of the decoder block 112 and/or text prediction layer can be adjusted when the predicted token is incorrect. In some cases, a generative language model can be pretrained on a large corpus of documents. Then, a pretrained generative language model can be tuned using a reinforcement learning technique such as reinforcement learning from human feedback (“RLHF”).

### Example Generative Image Model

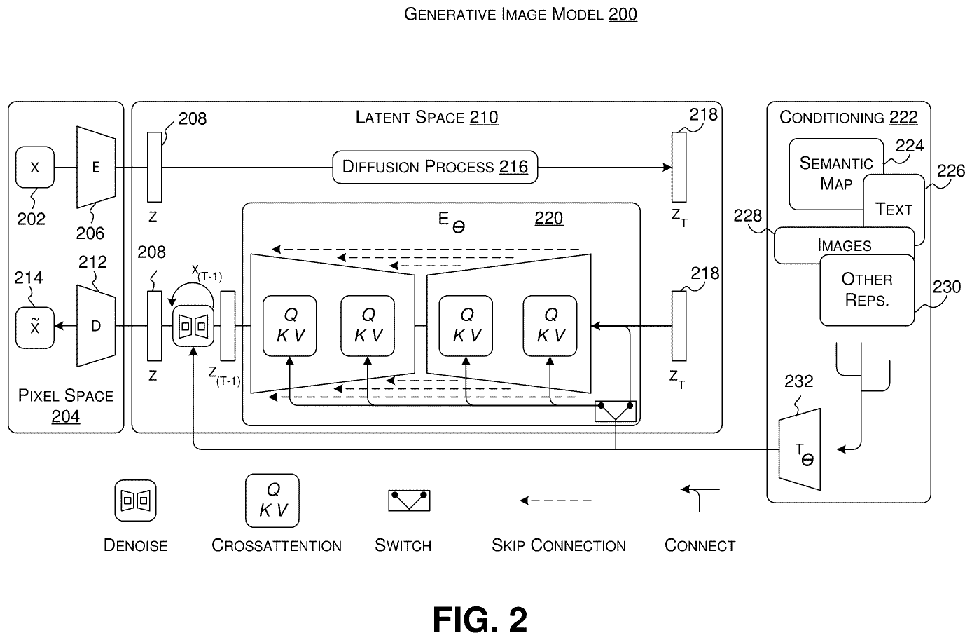

FIG. 2 illustrates an example generative image model 200. An image 202 (X) in pixel space 204 (e.g., red, green, blue) is encoded by an encoder 206 (E) into a representation 208 (Z) in a latent space 210. A decoder 212 (D) is trained to decode the latent representation Z to produce a reconstructed image 214 (X~) in the pixel space. For instance, the encoder can be trained (with the decoder) as a variational autoencoder using a reconstruction loss term with a regularization term.

In the latent space 210, a diffusion process 216 adds noise to obtain a noisy representation 218 (Z_{T}). A denoising component 220 (E_{θ}) is trained to predict the noise in the compressed latent image Z_{T}. The denoising component can include a series of denoising autoencoders implemented using UNet 2D convolutional layers.

The denoising can involve conditioning 222 on other modalities, such as a semantic map 224, text 226, images 228, or other representations 230 which can be processed to obtain an encoded representation 232 (T_{θ}). For instance, text can be encoded using a text encoder (e.g., BERT, CLIP, etc.) to obtain the encoded representation. This encoded representation can be mapped to layers of the denoising component using cross-attention. The result is a text-conditioned latent diffusion model that can be employed to generate images conditioned on text inputs. To train a model such as CLIP, pairs of images and captions can be obtained from a dataset to encode both the images and captions, and the encoder can be trained to represent pairs of images and captions with similar embeddings.

Generative image model 200 can be employed for text to image generation, where an image is generated from a text prompt. Text prompts can be provided by users or generated automatically by machine learning using the disclosed techniques. In other cases, generative image model 200 can be employed for image-to-image mode, where an image is generated using an input image as well as a user or machine-generated text prompt. Generative image model 200 can also be employed for inpainting, where parts of an image are masked and remain fixed while the rest of the image is generated by the model, in some cases conditioned on a user or machine-generated text prompt.

In some cases, generative image model 200 can be implemented as a Stable Diffusion model (Rombach, et al., “High-Resolution Image Synthesis with Latent Diffusion Models,” Proceedings of the IEEE/CVF Conference on Computer Vision and Pattern Recognition, 2022), which can be guided by a separate network, such as a ControlNet (Zhang, et al., “Adding Conditional Control to Text-to-Image Diffusion Models,” Proceedings of the IEEE/CVF International Conference on Computer Vision, 2023). For instance, a ControlNet can guide the generative model to produce an image that preserves certain aspects of another image, e.g., the spatial layout and salient features of an image prior. A ControlNet can be implemented by locking the parameters of generative image model 200, cloning the model into another copy. The copy is connected to the original model with one or more zero convolutional layers which are then optimized with the parameters of the copy. For instance, the ControlNet can be trained to preserve edges, lines, boundaries, human poses, semantic segmentations, etc. from an image. A ControlNet can also be trained to preserve depth relationships of a user-identified image using a depth map obtained from the user-identified image, etc. The outputs of a ControlNet can be added to connections within the denoising layer. Thus, the generative image model can produce images that are conditioned not only on text, but also aspects of another image.

### Generative Modes

Generative image model 200 can implement a number of different modes. In a text-to-image mode, an image is generated from a given text prompt. In an image-to-image mode, an image is generated from a text prompt and an input image, and the generated image retains features of the input image while introducing new elements or styles consistent with the prompt. In inpainting/outpainting mode, the processing is similar to the image-to-image mode, but an image mask is used to determine which parts of the image are fixed to match the input image. The rest of the image is generated in a way that is consistent with the fixed parts of the image. Note that the term “inpainting,” as used herein, includes filling in parts of a given image whereas “outpainting” refers to extending an image outward.

### Example Computer Vision Model

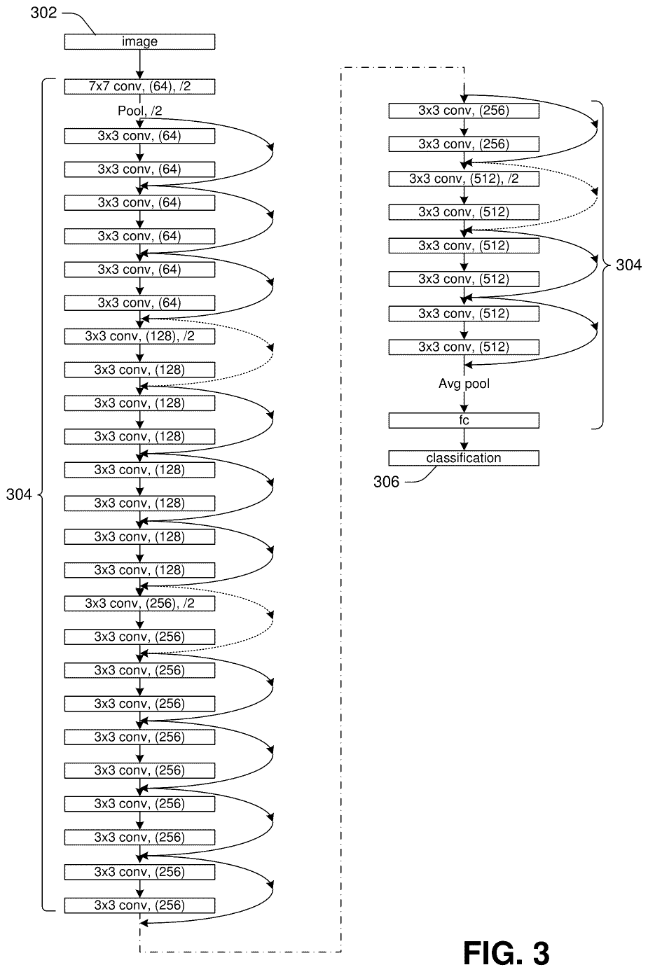

FIG. 3 illustrates a particular example of a neural network model for computer vision. For instance, FIG. 3 shows an image 302 being classified by a computer vision model 304 to determine an image classification 306, where the computer vision model can be a ResNet model (He, et al., “Deep Residual Learning for Image Recognition,” in Proceedings of the IEEE Conference on Computer Vision and Pattern Recognition, 2016, pp. 770-778). The computer vision model can include a number of convolutional layers, most of which have 3×3 filters. Generally, given the same output feature map size, the convolutional layers have the same number of filters (e.g., 64, 128, 256, 512). If the feature map size is halved by a given convolutional layer (as shown by “/2” in FIG. 3), then the number of filters can be doubled to preserve the time complexity across layers.

After the image has been processed using a series of convolutional layers, the image is processed in a global average pooling layer. The output of the pooling layer is processed with a fully-connected layer with softmax. The fully-connected layer (e.g., one thousand-way) can be used to determine a classification, e.g., an object category of an object in image 302.

The respective layers within computer vision model 304 can have shortcut connections which perform identity operations:

$$y = F ( x , \{ {W}_{i} \} ) + x \qquad ( 1 )$$

where x and y are the input and output vectors of the layers involved and F(x, {Wᵢ}) represents the residual mapping learned by the model. In some connections the dimensions increase across layers (shown as dotted lines in FIG. 3). In these cases, the following projection can be employed to match the dimensions via 1×1 convolutions:

$$y = F ( x , \{ {W}_{i} \} ) + {W}_{s} x \qquad ( 2 )$$

In some implementations, computer vision model 304 can be pretrained on a large dataset of images, such as ImageNet. Such a general-purpose image database can provide a vast number of training examples that allow the model to learn weights that allow generalization across a range of object categories. Said another way, computer vision model 304 can be pretrained in this fashion.

After pretraining, computer vision model 304 can be tuned on another, smaller dataset for categories of interest. For instance, tuning datasets can be provided for specific groups of users. As one example, software developers might tend to use UML (Unified Modeling Language) diagrams or directed acyclic graphs, whereas other users might tend to use conventional flow charts, and thus different computer vision models can be tuned for these different sets of users. As another example, social media users might tend to post images of things in their home, such as pets or furniture, whereas business users might tend to post images of graphs, scatterplots, pie charts, etc.

### Example Vision Language Model

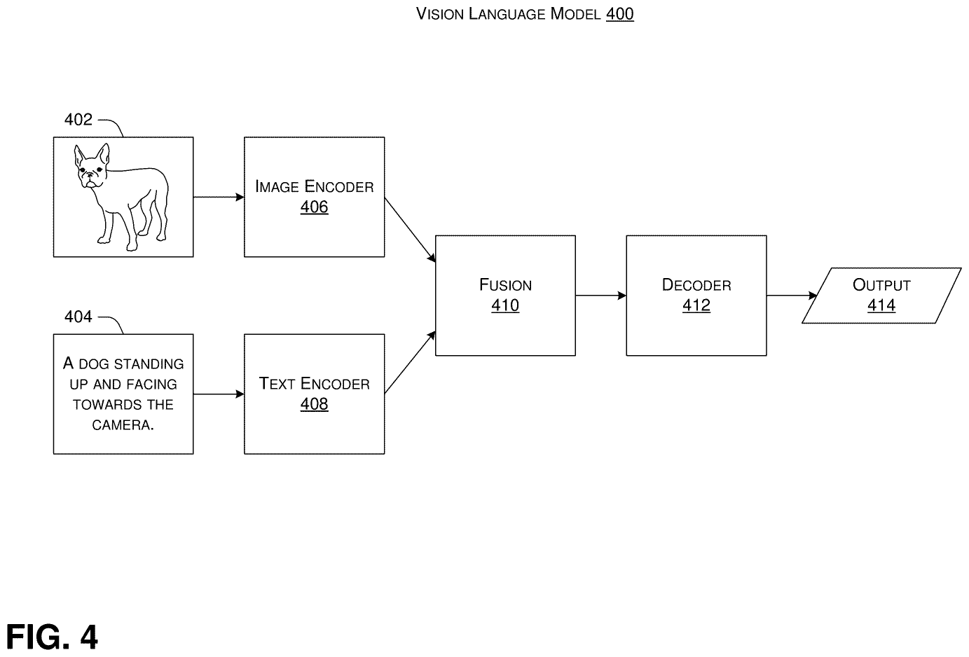

FIG. 4 shows an example vision language model 400 that can process an input image 402 and/or a text input 404. The input image is processed using an image encoder 406 (e.g., based on computer vision model 304) and the text input is processed using a text encoder 408. The image encoder and text encoder produce encodings (e.g., vector embeddings) representing the input image and text input, respectively. A fusion process 410 can fuse the encodings using techniques such as attention, dot product, etc. A decoder 412 can decode the fused encodings to produce an output 414.

In some implementations, the image encoder can also be based on a transformer architecture such as a Vision Transformer (Dosovitskiy, et al., “An Image is Worth 16×16 Words: Transformers for Image Recognition at Scale,” Jun. 3, 2021, arXiv preprint arXiv:2010.11929v2). The text encoder 408 can be based on a transformer architecture such as BERT or GPT. In other cases, an “early fusion” approach can employ a shared encoder that processes sequences of text and image tokens using a single encoder that determines embeddings for each text or image token. (Chameleon. Team C, “Chameleon: Mixed-Modal Early-Fusion Foundation Models,” 2024, arXiv preprint, arXiv:2405.09818).

The vision language model 400 can be trained using approaches such as contrastive learning, where the training data includes pairs of text and images and the model is trained to determine whether a given text sample matches a corresponding image sample. In this manner, the image encoder 406 and the text encoder 408 can be trained to generate similar embeddings for text and images that represent similar concepts (e.g., the word “bear” and an image of a bear). Other approaches include masked image modeling and/or masked language modeling and image-text modeling.

The output 414 can characterize an image. For instance, the output can answer a visual question, caption the image, etc. The output can also identify detected objects, classify detected objects, perform image segmentation, etc. In some cases, the vision language model 400 can determine a label for an object in an input image. The labels can identify a category of the object (e.g., “bed” or “sofa”), a description of the object (e.g., “a queen-sized bed with blue bedding and a headboard”), or even specify information such as a brand of the object (e.g., “ABC brand queen size platform bed”), etc. The output can also specify relationships between detected objects, e.g., “the bear is riding the unicycle in the circus ring,” etc.

### First Example User Experience

The following illustrates an example user experience consistent with the disclosed concepts. Note that the following description employs a task involving creation of a slide deck with a generative machine learning model, using specific examples of graphic user interface elements. However, as discussed more below, the present concepts can be implemented for a wide range of content creation tasks, such as creating word processing documents, web pages, audio, video, three-dimensional content, etc. The present concepts can also be implemented using a wide range of user interface techniques, in addition to those shown below.

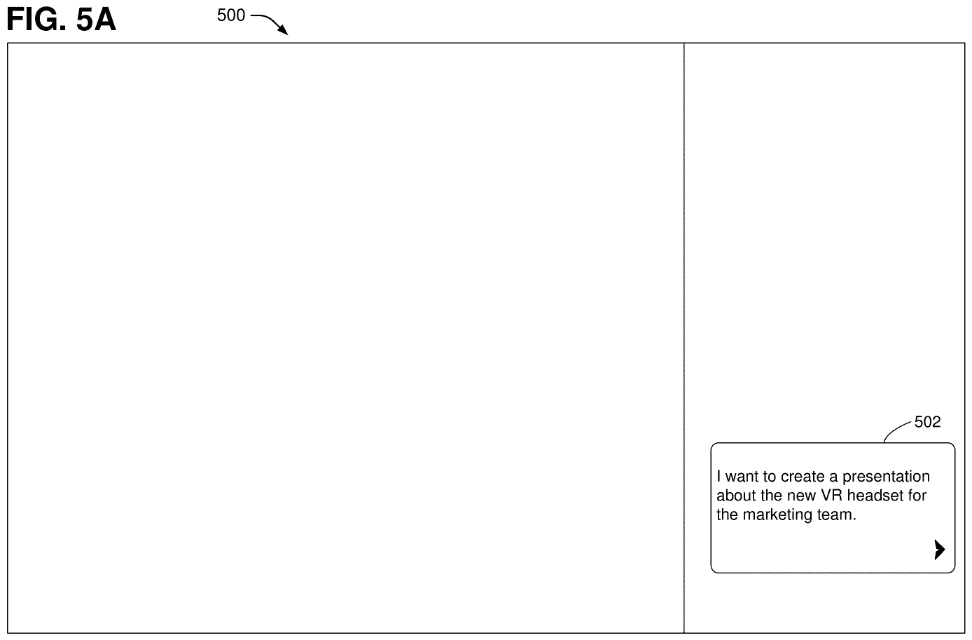

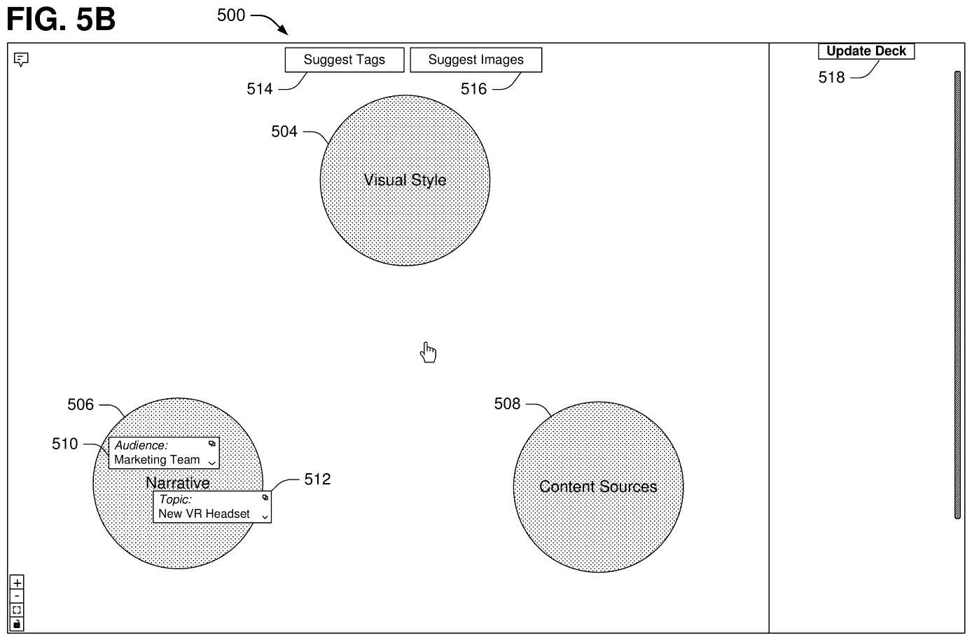

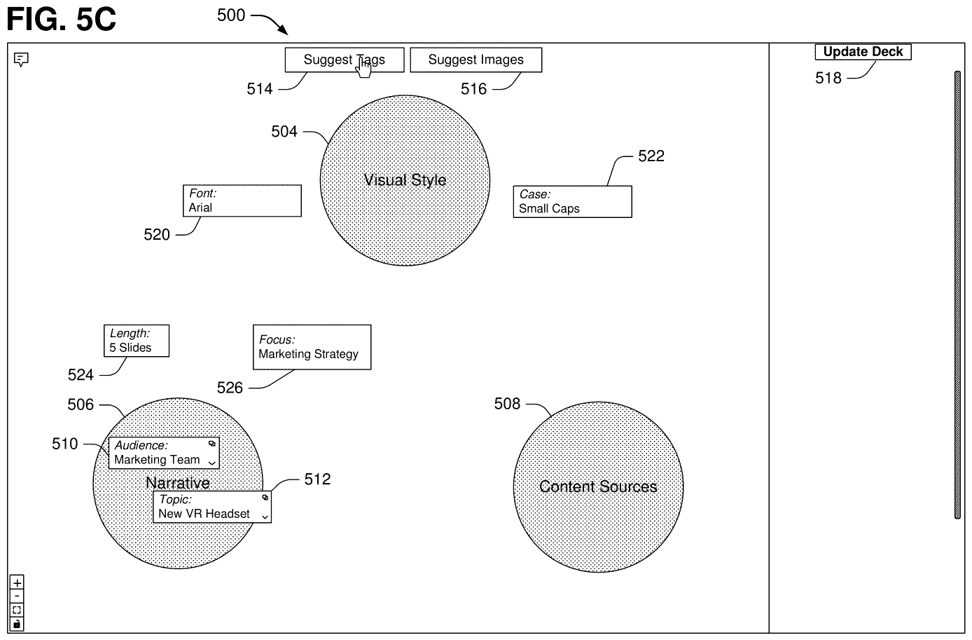

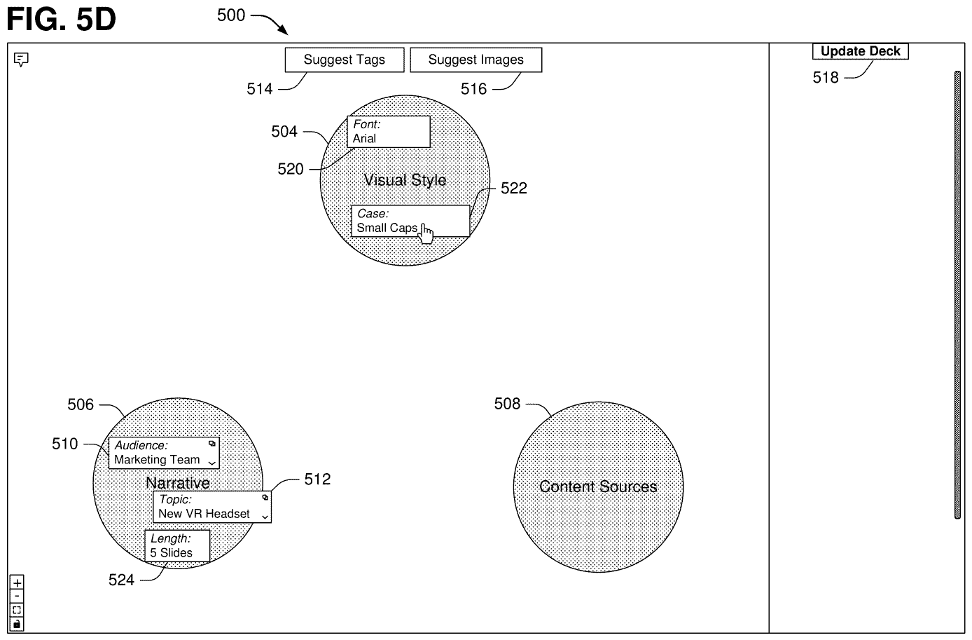

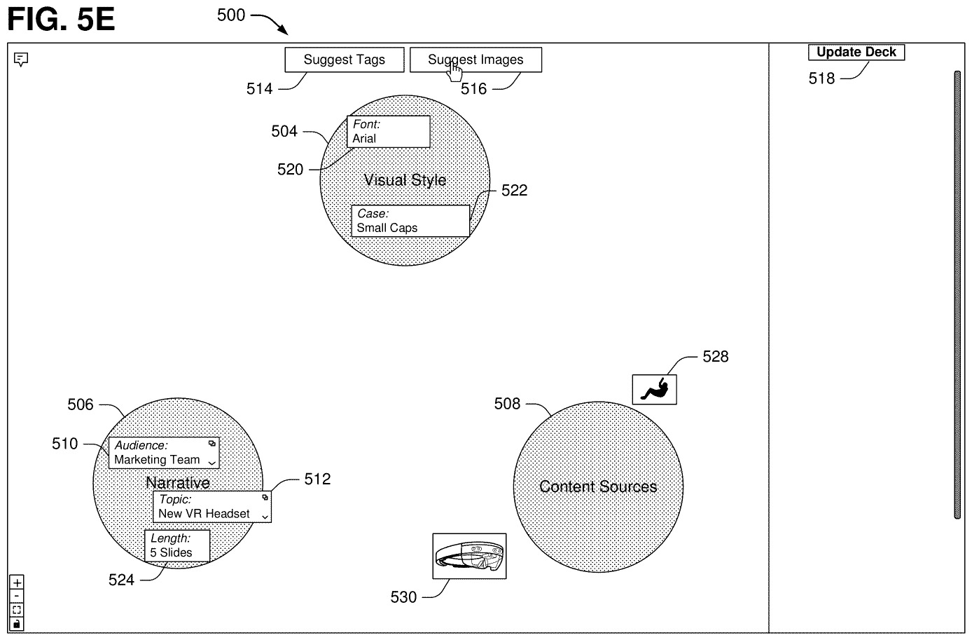

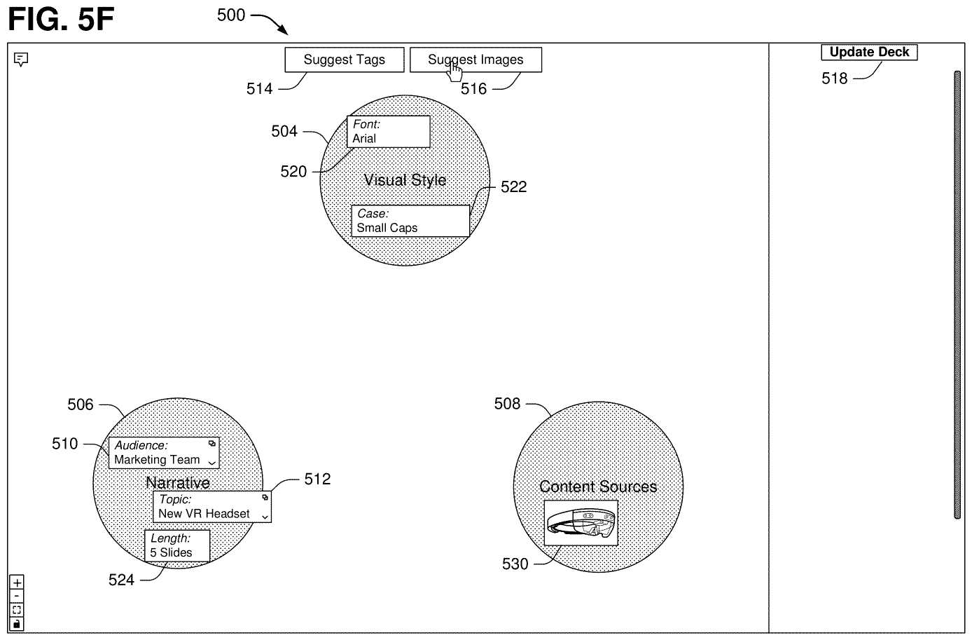

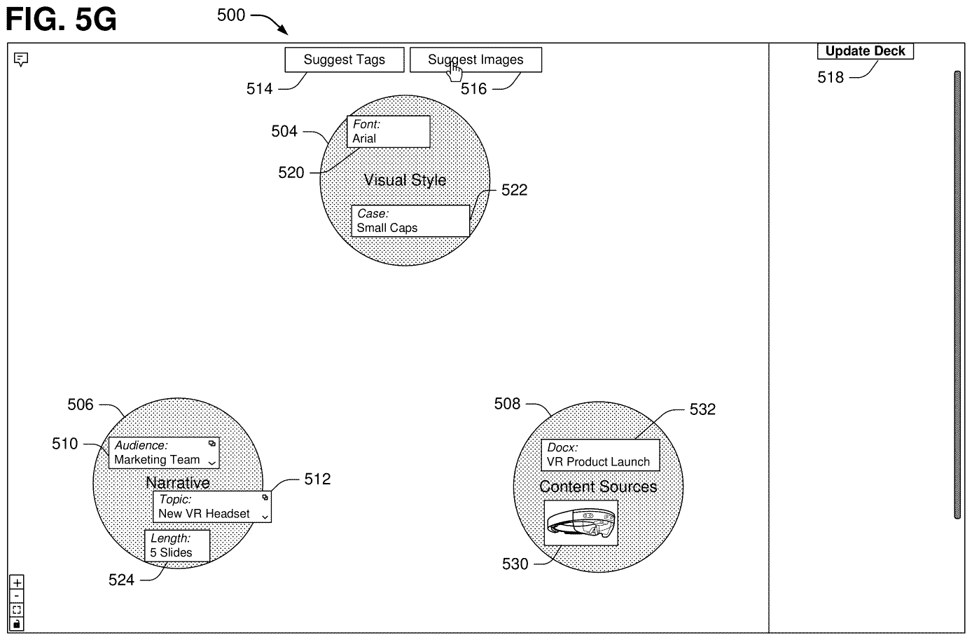

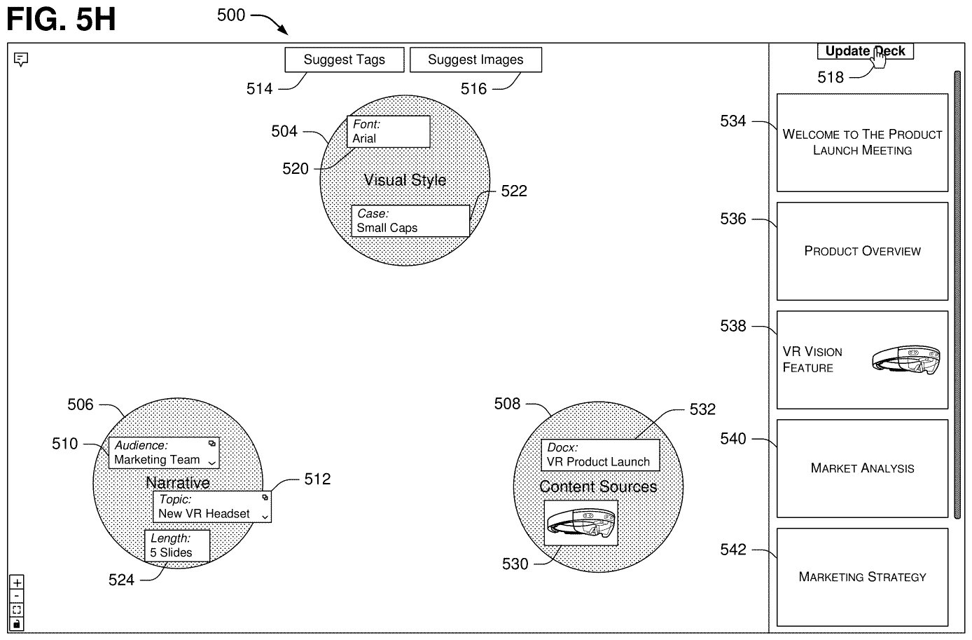

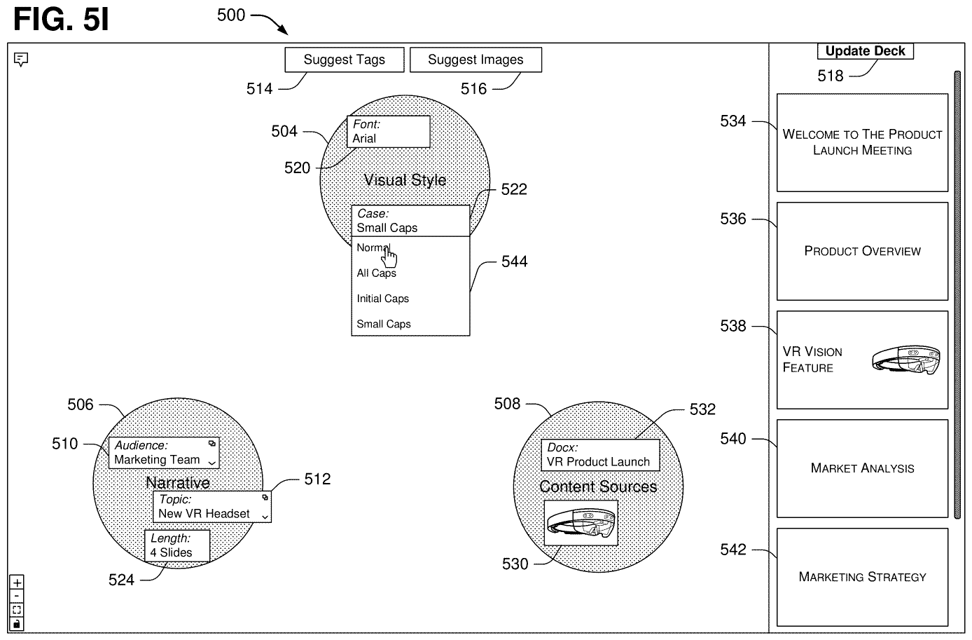

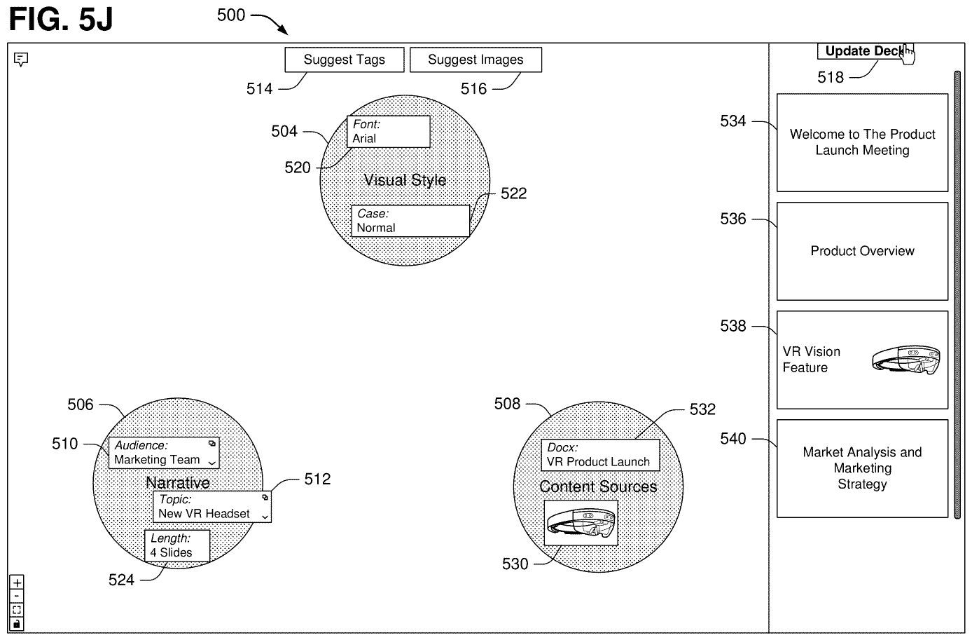

FIG. 5A shows an example user interface 500 for a slide deck presentation. A user enters a user prompt in a prompt area 502. Here, the user prompt indicates that the user wishes to generate a presentation about a new virtual reality headset for their marketing team.

Next, in FIG. 5B, user interface 500 is updated to include three tag steering elements—a visual style tag steering element 504, a narrative tag steering element 506, and a content sources tag steering element 508. The narrative tag steering element 506 is prepopulated with two concept tags—concept tag 510 has a property of “Audience” with a value of “Marketing Team,” and concept tag 512 has a property of “Topic” with a property of “New VR Headset.” For instance, the generative machine learning model can be prompted to predict or suggest these concept tags for the slide deck presentation based on the user prompt shown in FIG. 5A. In addition, note that the user interface also includes a suggest tags element 514, a suggest images element 516, and an update deck element 518, which will be explained in more detail below.

Next, in FIG. 5C, the user selects suggest tags element 514. In response, user interface 500 is updated with several predicted or suggested concept tags-concept tag 520, concept tag 522, concept tag 524, and concept tag 526. For instance, the generative machine learning model can be prompted to predict or suggest these additional concept tags for the slide deck presentation based on concept tag 510, concept tag 512, and/or the user prompt shown in FIG. 5A. Note, however, that while concept tag 510 and concept tag 512 were initially displayed within the narrative tag steering element 506, the newly-suggested concept tags are displayed outside of the tag steering elements. For this example, a given concept tag is not selected by a user until the user drags that concept tag into one of the tag steering elements. Thus, in FIG. 5C, concept tag 510 and concept tag 512 are currently selected by the user, while concept tag 520, concept tag 522, concept tag 524, and concept tag 526 are not currently selected.

Next, in FIG. 5D, the user drags concept tag 520 and concept tag 522 into the visual style tag steering element 504. The user also drags concept tag 524 into the narrative tag steering element 506. Concept tag 526 is not selected by the user and can automatically be removed from the graphical user interface 500 after not being selected for a specified amount of time (e.g., one minute). In other implementations, concept tags can remain on the graphical user interface until manually removed by the user, e.g., by identifying a given tag with a cursor and hitting backspace or delete, right-clicking and selecting a “delete” option from a menu, a tap-and-hold or double tap gesture, etc.

Next in FIG. 5E, the user selects the suggest images element 516. The user interface is updated with reference tag 528 corresponding to a first predicted or suggested image and reference tag 530 corresponding to a second predicted or suggested image. For instance, the predicted or suggested images can be obtained by performing an image search using a web search engine based on the initial user prompt and/or any currently-selected intent tags. In other implementations, a generative image model can be prompted to generate predicted or suggested images based on the initial user prompt and/or any currently-selected intent tags.

Next, in FIG. 5F, the user drags reference tag 530 into the content sources tag steering element 508. By dragging reference tag 530 into the content sources tag steering element, the user has selected the predicted or suggested image of the VR headset associated with this reference tag. Reference tag 528 is not selected by the user and can automatically be removed from the graphical user interface 500 after not being selected for a specified amount of time (e.g., one minute). In other implementations, reference tags for suggested images can remain on the graphical user interface until manually removed by the user.

Next, in FIG. 5G, the user manually adds a reference tag 532 to the content sources tag steering element. This reference tag refers to a word processing document, which has a .docx file extension. For instance, the word processing document may be located on the user's local computing device or obtained from cloud storage. The user can manually create the reference tag by dragging and dropping a word processing document from a web page, desktop, file explorer, etc. In some cases, the user can select a particular portion of a given document that they wish to utilize (e.g., by highlighting a portion of a word processing document).

Next, in FIG. 5H, the user selects update deck element 518. In response, five slides are created-slide 534, slide 536, slide 538, slide 540, and slide 542. For instance, a generative machine learning model can be prompted to generate content for each slide. In some implementations, the generative machine learning model can also generate an outline (not shown) for the slide deck.

Next in FIG. 5I, the user selects concept tag 522 and a menu 544 appears adjacent to the selected concept tag. The menu is populated with possible values (predicted or suggested by the generative machine learning model) for the “Case” property associated with this concept tag. The user selects “Normal” case as the value for concept tag 522. In some cases, the possible values are defined statically, e.g., using a stored list. In other cases, a generative machine learning model is prompted to suggest possible alternative values for a given concept tag, and the menu is populated with the alternative values suggested by the generative machine learning model. In addition, the user manually edits concept tag 524 to change the length property from five slides to four slides, e.g., by moving the cursor over the concept tag and typing the new value.

Next in FIG. 5J, the user selects update deck element 518 again. The generative machine learning model is prompted to modify the slide deck based on the based on the initial user prompt and/or any currently-selected intent tags. Since the values for concept tag 522 and concept tag 524 have changed, the slide deck is updated accordingly. Note that there are now four slides corresponding to the new value for concept tag 524, with slide 542 having been removed and slide 540 having been modified by the generative machine learning model to condense the information from slide 542 into slide 540. In addition, note that the slides are no longer in small caps, but rather have normal capitalization based on the new value in concept tag 522.

### Second Example User Experience

In the example shown above with respect to FIGS. 5A-5J, the user was able to modify the entire slide deck at once based on the initial user prompt and/or the currently-selected intent tags. However, in some cases, a user may wish to individually modify an individual slide while leaving the remaining slides unaltered.

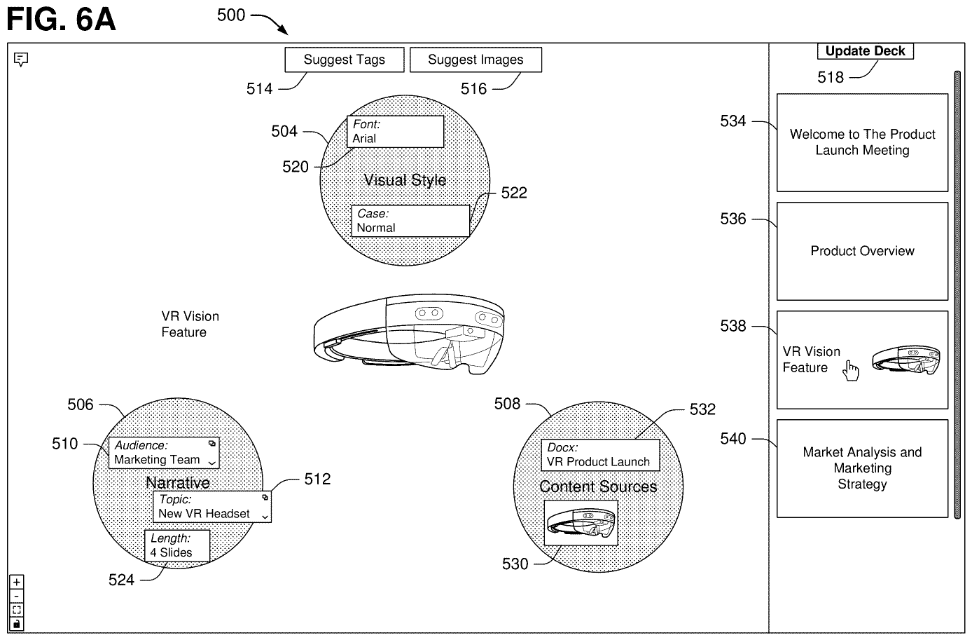

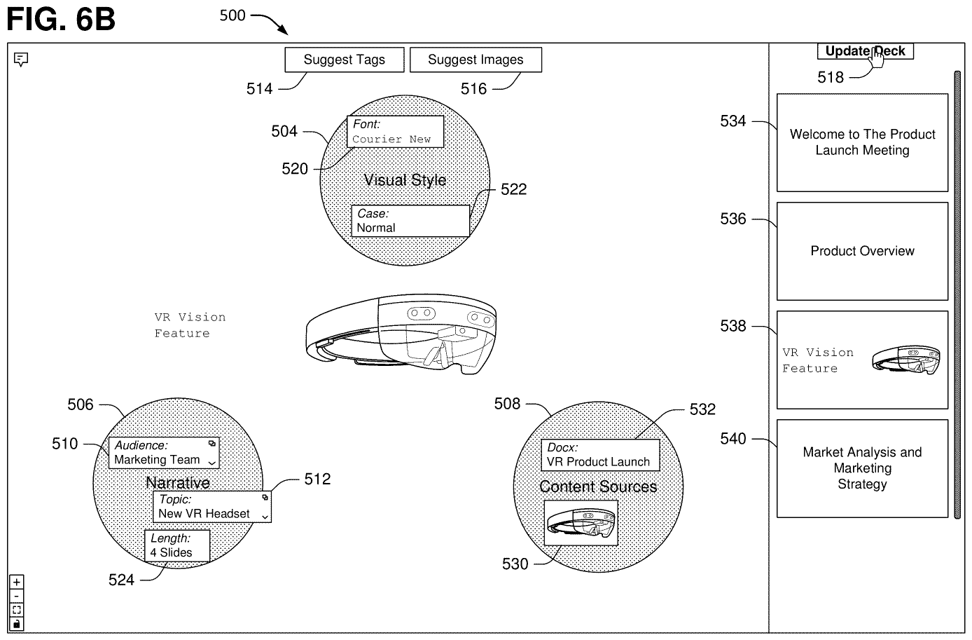

For instance, as shown in FIG. 6A, the user selects slide 538 to edit this slide individually. Graphical user interface 500 is updated to show the content of slide 538 together with the tag steering elements and intent tags. Next, in FIG. 6B, the user manually types the value “Courier New” into the concept tag 520. The user then selects update deck element 518, but in this case the updates are only applied to the currently-selected slide. Thus, as shown in FIG. 6B, the font in slide 538 is updated, while the font remains with the previous font (Arial) in the other slides.

Note that users can also perform other types of modifications to an individual slide, similar to those described above for modifying the entire slide deck. For instance, users can request predicted or suggested tags for a given slide via suggest tags element 514, and then a generative machine learning model can be prompted to predict or suggest concept tags based on the content of the currently-selected slide as well as the currently-selected intent tags for that slide. Similarly, users can request predicted or suggested images for a given slide via suggest images element 516, and then a web search and/or a generative image model can be employed to obtain predicted or suggested images for the currently-selected slide based on the content of the currently-selected slide as well as the currently-selected intent tags for that slide. Users can then drag predicted or suggested concept tags and/or reference tags for suggested images into a corresponding tag steering element to guide further generation of content for the currently-selected slide. Likewise, users can add a reference tag to an external document (or a portion thereof) to the content sources tag steering element 508, and the generation of content for the currently-selected slide can be based on the content of that external document.

### Additional User Interface Element Examples

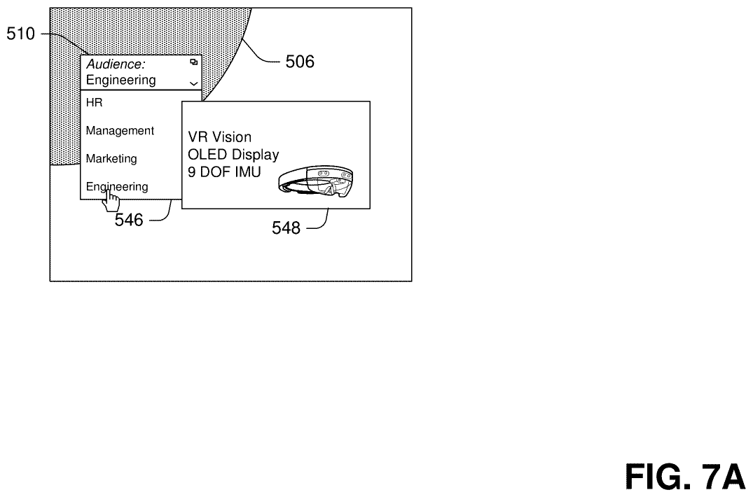

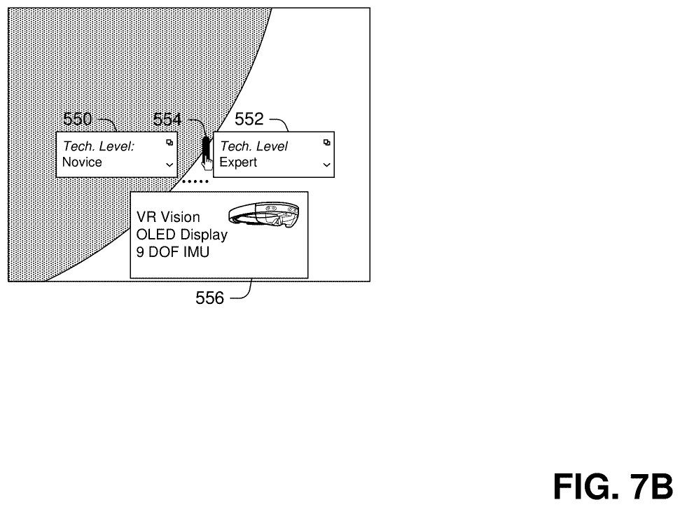

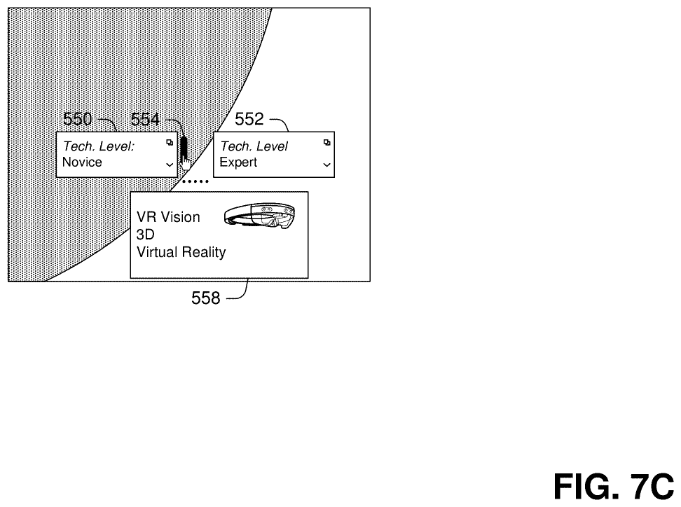

The description above provided several different user interface elements for employing intent tags to determine user intent with respect to different characteristics of a slide deck being generated for the user. FIGS. 7A-7C show some additional user interface techniques that can be employed in this regard.

FIG. 7A shows an expanded view of user interface 500 with a portion of narrative tag steering element 506 visible. The user has selected concept tag 510 and changed the value to “engineering” via dropdown 546. A slide preview 548 shows a modified version of slide 538, updated for the engineering audience. In this manner, the user is able to see how the generated content might change if they modify the value of a given intent tag.

FIG. 7B shows an alternative with an intent tag 550 and an intent tag 552 represent opposite ends of a range for a particular property, in this case, the technical level of the presentation. Intent tag 550 has a value of “novice” for the technical level property, while intent tag 552 has a value of “expert” for the technical level property. A user has employed a slider 554 to move to the maximum value of “expert” represented by intent tag 552. Slide preview 556 shows a modified version of slide 538 with expert level technical content produced by a generative machine learning model that has been prompted to generate expert-level technical content.

FIG. 7C shows a scenario where the user has moved slider 554 next to intent tag 550, corresponding to the novice value. Slide preview 558 shows a modified version of slide 538 with novice level technical content produced by a generative machine learning model that has been prompted to generate novice-level technical content.

In some cases, a generative machine learning model can also be prompted to predict or suggest values within a given range for a particular property. For instance, a generative machine learning model could be prompted to generate five levels of technical expertise for a slide presentation relating to a virtual reality device. The generative machine learning model could respond with novice level, hobbyist level, undergraduate level, skilled engineer level, and expert level values for this property. Each level can be selected by a corresponding position of slider 554 or other moveable user interface element.

### Image Modification Example

The examples above describe how intent tags can be employed to guide content generation for a slide deck. However, the present concepts can be employed to generate many different types of content. The following shows an alternative example where a user provides an image for subsequent modification, where the modification is guided using intent tags.

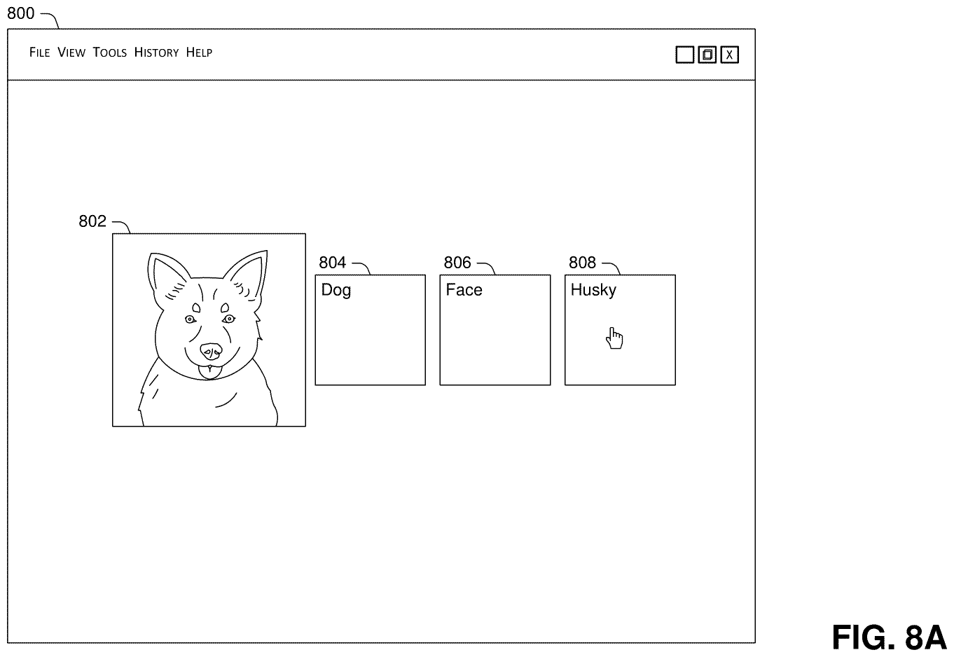

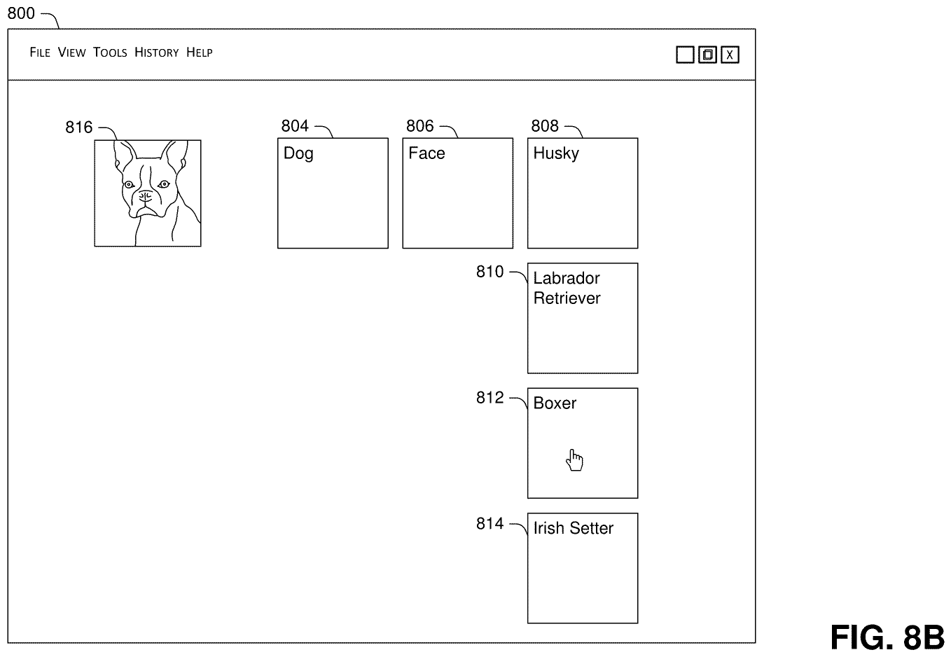

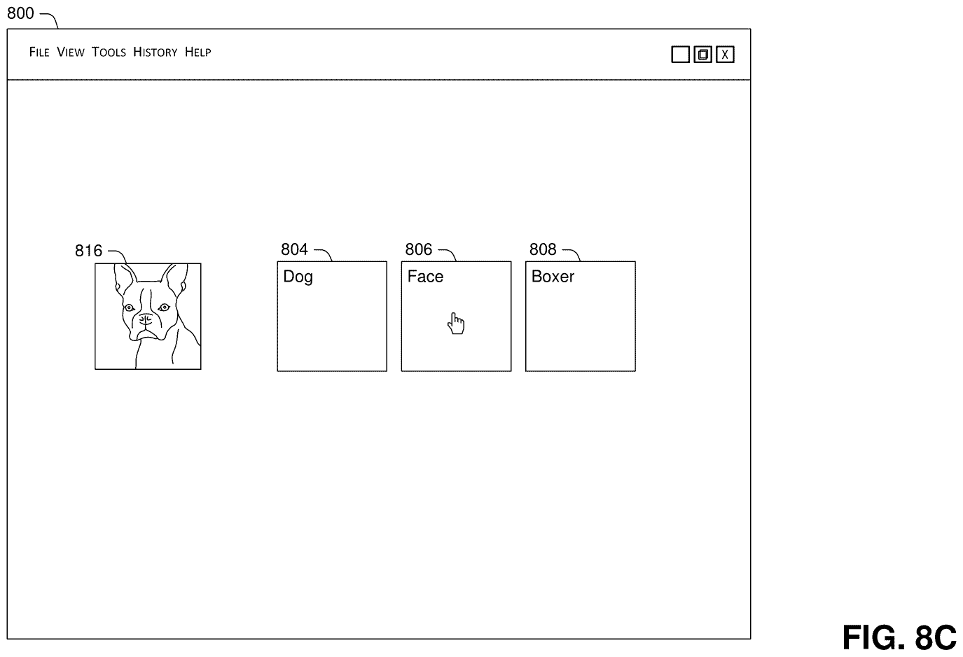

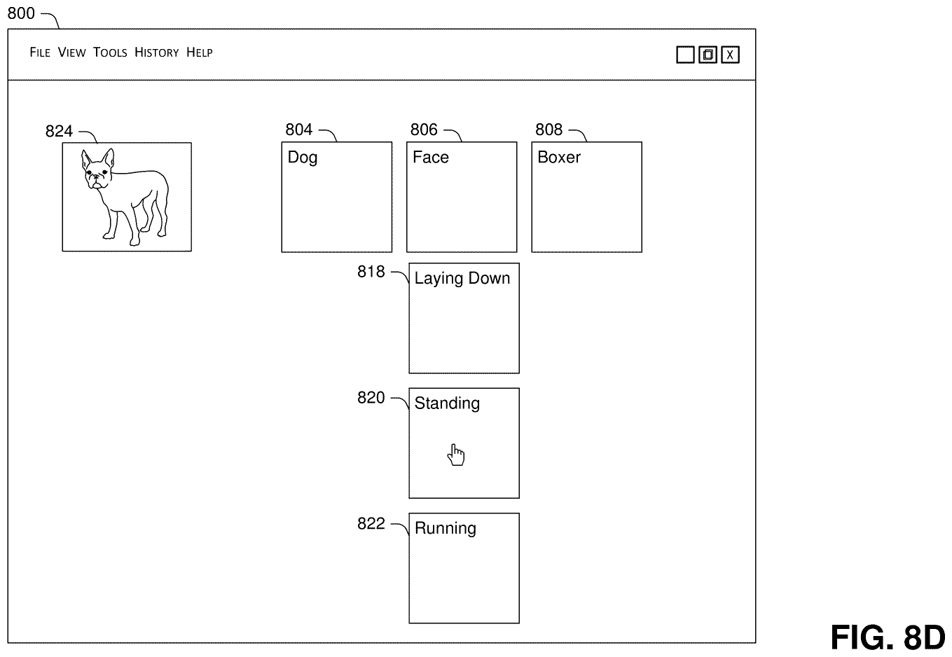

FIG. 8A shows a graphical user interface 800 where a user starts with an input image 802. Intent tag 804, intent tag 806, and intent tag 808 are extracted from the image. For instance, a vision language model could analyze the image and output a response such as “A Husky-type dog facing the camera.” A generative machine learning model could then be prompted based on output of the vision language model to determine predicted or suggested intent tag properties for modification of the image. For the following example, assume the generative language model suggests a “species” property, a “pose” property, and a “breed” property.

The user hovers over intent tag 808, which corresponds to the breed property. Next, in FIG. 8B, intent tag 808 expands to include alternate intent tags-intent tag 810, intent tag 812, and intent tag 814. Each of these intent tags represents an alternative value for the breed property suggested by the generative machine learning model. The user selects intent tag 812 corresponding to the boxer breed, resulting in a modified image 816 showing a facial shot of a boxer. For instance, a generative image model could be instructed to modify input image 802 to show a boxer in place of a husky.

Next, in FIG. 8C, the user hovers over intent tag 806, which corresponds to the pose property. Next, in FIG. 8D, intent tag 806 expands to show alternate intent tags-intent tag 818, intent tag 820, and intent tag 822. Each of these intent tags represents an alternative value for the pose property predicted or suggested by the generative machine learning model. The user selects intent tag 820 corresponding to the standing pose, resulting in modified image 824. For instance, a generative image model could be instructed to further change modified image 816 to show a boxer in a standing pose instead of a facial shot.

### Example System

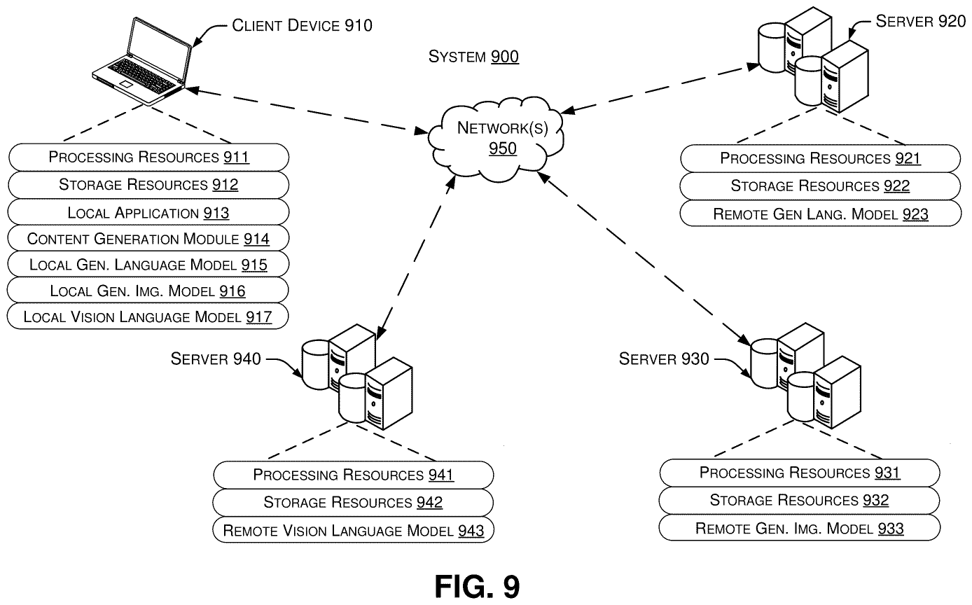

The present implementations can be performed in various scenarios on various devices. FIG. 9 shows an example system 900 in which the present implementations can be employed, as discussed more below.

As shown in FIG. 9, system 900 includes a client device 910, a server 920, a server 930, and a server 940, connected by one or more network(s) 950. Note that the client device can be embodied both as a mobile device such as smart phones or tablets, as well as stationary devices such as desktops, server devices, etc. Likewise, the servers can be implemented using various types of computing devices. In some cases, any of the devices shown in FIG. 9, but particularly the servers, can be implemented in data centers, server farms, etc.

Client device 910 can have processing resources 911 and storage resources 912, server 920 can have processing resources 921 and storage resources 922, server 930 can have processing resources 931 and storage resources 932, and server 940 can have processing resources 941 and storage resources 942. Each of these devices may also have various modules that function using the processing and storage resources to perform the techniques discussed herein. The storage resources can include both persistent storage resources, such as magnetic or solid-state drives, and volatile storage, such as one or more random-access memory devices. In some cases, the modules are provided as executable instructions that are stored on persistent storage devices, loaded into the random-access memory devices, and read from the random-access memory by the processing resources for execution.

Client device 910 can include one or more local application(s) 913, such as an email client, web browser, word processing application, social media application, photo or video repository application, etc. The client device can also include a content generation module 914, which can interact with one or more local or remote models to implement the concepts disclosed herein. For instance, the content generation module can receive data from the local application indicating what user prompts have been entered, what intent tags and/or intent tag values have been selected by the user, etc. The content generation module can prompt the respective local and remote models in system 900 to obtain generated content, and provide the generated content to the local application 913 for output. In some cases, the content generation module is implemented as part of the local application, and in other cases is implemented as a separate module (e.g., as part of an operating system or library).

The client device can also include a local generative language model 915, e.g., a local instance of generative language model 100 as shown in FIG. 1. The client device can also include a local generative image model 916, e.g., a local instance of generative image model 200 as shown in FIG. 2. The client device can also have a local vision language model 917, e.g., a local instance of vision language model 400 shown in FIG. 4.

Server 920 can host remote generative language model 923, e.g., a remote instance of generative language model 100 as shown in FIG. 1. Server 930 can host a remote generative image model 933, e.g., a remote instance of generative image model 200 as shown in FIG. 2. Server 940 can host remote vision language model 943, e.g., a remote instance of vision language model 400 shown in FIG. 4.

### Example Method

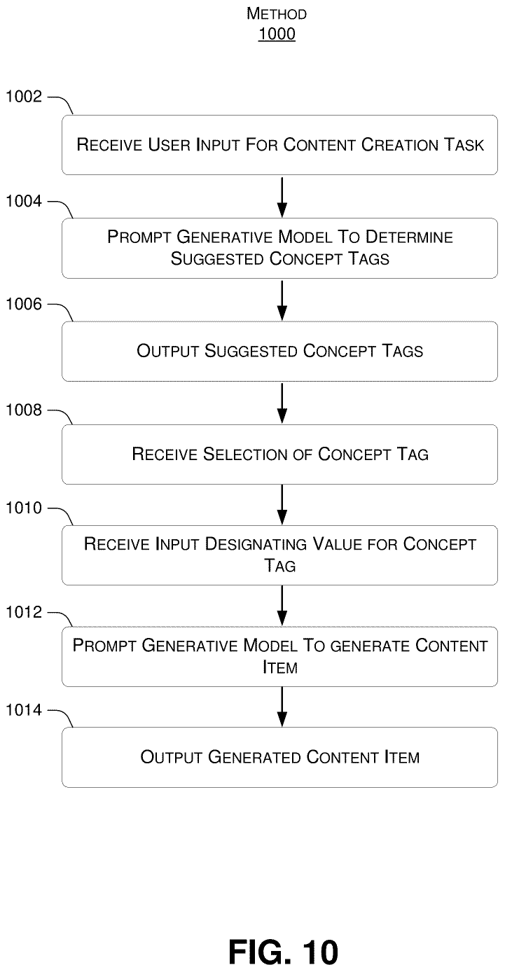

FIG. 10 illustrates an example computer-implemented method 1000, consistent with some implementations of the present concepts. Method 1000 can be implemented on many different types of devices, e.g., by one or more cloud servers, by a client device such as a laptop, tablet, or smartphone, or by combinations of one or more servers, client devices, etc.

Method 1000 begins at block 1002, where user input relating to a content creation task involving generation of content including one or more content items is received. For instance, the user input can be a text or voice prompt describing the content to be created, a gesture, an image, a video or audio file, a document, etc. The user input can also include one or more concept or reference tags.

Method 1000 continues at block 1004, where a generative machine learning model is prompted to determine one or more predicted or suggested concept tags for the content creation task. For instance, the generative machine learning model can be prompted to suggest concept and/or reference tags based on user context, such as the user input received at block 1002.

Method 1000 continues at block 1006, where the one or more predicted or suggested concept tags are output on a user interface. For instance, the suggested concept tags can be output in a designated area of the user interface for inactive tags. In some implementations, block 1006 can also include outputting one or more suggested reference tags.

Method 1000 continues at block 1008, where a selection of a selected concept tag is received via the user interface. The selected concept tag can be associated with a selected property having multiple possible values. For instance, the selected concept tag can be identified by dragging a concept tag into a designated area such as the tag steering elements described above with respect to FIGS. 5A-5J. As another example, a selected concept tag can be identified by user input selecting a column corresponding to a property, as in FIGS. 8A-8D. In some cases, block 1008 can also include receiving user input selecting a suggested reference tag and/or manually creating a new concept tag or reference tag. For instance, users can create new concept tags by moving the cursor into a given tag steering element and typing a property and/or value for the new manually-created tag.

Method 1000 continues at block 1010, where user input is received designating a particular value for a selected property associated with the selected concept tag. For instance, the user input can involve manually entering the particular value, selecting the particular value from a displayed menu (as in FIG. 5I), or selecting a particular row corresponding to the particular value (as in FIGS. 8B and 8D).

Method 1000 continues at block 1012, where the generative machine learning model is prompted to generate a particular content item based at least on the particular value for the selected property. For instance, the content item can be one or more slides of a slide deck, an outline of a slide deck, a word processing document, a web page, a spreadsheet, an image, audio, and/or video, etc.

Method 1000 continues at block 1014, where the particular content item is output via the user interface. For instance, FIG. 5H shows outputting five generated slides, FIG. 7A shows outputting a generated slide preview 548, FIG. 8B shows outputting a modified image 816, FIG. 8D shows outputting a modified image 824, etc.

### Additional Implementations

The specific user interface interactions described above are non-limiting, and many other user interface techniques can be employed to obtain user expressions of user intent consistent with the disclosed concepts. For instance, consider an alternative implementation where the tag steering elements shown in FIGS. 5A-5J have concentric areas, with an inner “nucleus” and an outer ring. Users could drag intent tags into the nucleus to express a firm intent to utilize a particular intent tag for content generation, and could drag other intent tags into the outer ring to express a less-firm preference to use those intent tags for content generation. Then, a generative model could be prompted to generate content where the intent tags in the outer ring are deemed optional but the intent tags in the nucleus are non-optional. More generally, the relative proximity of a given intent tag to the center of a tag steering area (or other graphical element for selecting tags) could be used to weigh how strongly each tag influences content generation. For instance, a generative model could be prompted with numerical weights for each intent tag, with the numerical weights being relatively higher for tags close to the center of the tag steering area and relatively lower for tags further away from the center. In addition, note that circular selection areas such as the tag steering areas shown in FIGS. 5A-5J are just one example of a suitable shape, and some implementations can employ other shapes (e.g., rectangular areas) for selecting intent tags.

In addition, note that there are many other ways for users to select a given intent tag besides those shown above. For instance, users can click, double-click, or tap on a given intent tag to select that intent tag, or use a designated sequence of keystrokes to select a given intent tag. As another example, user gaze, gestures, or spoken instructions could be used to create, select, or modify intent tags.

In addition, the previous examples employed user context from current user input to the application in which content is being generated. Further implementations can employ additional information as user context. For instance, users may have predefined preferences that can be used for conditional generation of predicted or suggested intent tags and/or predicted or suggested intent tag values. As another example, users may have one or more files or documents open in another application while generating content, and those files or documents can be used to guide content generation. As one specific example, if a user has an email open in their email client while generating a word processing document, the content and/or recipients of that email could be used as additional context to guide the generative model to generate text for the word processing document. As another example, during a meeting, generation of intent tags and/or suggested values for intent tags could be conditioned on information such as characteristics (e.g., expertise levels, locations, age, job title, etc.) of meeting participants, meeting metadata (e.g., title), end user device type (e.g., mobile device vs. laptop), documents associated with the meeting, a meeting transcript, chat content, content of emails pertaining to the meeting, etc.

As another example, recall that the previous examples included performing a web search for images to include in a generated document. In further implementations, a web search can also be employed based on user input to search for documents. For instance, an initial user prompt and/or currently-selected tag values can be employed to search for documents, and reference tags can be created for each retrieve document (or a top-ranked subset of retrieved documents). Users could select part or all of a retrieved document to use for subsequent content generation.

As another example, some implementations can employ natural language conversation via a chat interface or speech recognition to infer user intent. For instance, a chat or speech-enabled agent could ask the user questions about their intent for generating content and then predicted or suggest tags/tag values based on the user's responses. The agent could also extract tag values directly based on the user's responses, and generate content for the user interactively during the chat. As another example, users could specify tags or tag values using text, e.g., with @ or # symbols being used during a chat to indicate when they want to specify a particular intent tag.

In addition, note that the tag steering groups provided above are examples of graphical elements for selecting tags in the context of generating a slide deck. However, different types of graphical elements could be employed for generating other types of content. For instance, a user generating a story could be provided with one graphical element for selecting tags relating to a plot of the story, another graphical element for selecting tags relating to characters in the story, another graphical element for selecting tags relating to illustrations generated by a generative image model for the story, etc. In addition, the tag groupings could be statically defined, or could be predicted or suggested by a generative model. In other words, a generative model could suggest the tag groups of visual style, narrative, and content sources for a slide deck, and the tag groups of plot, characters, and illustrations for a story.

In addition, some implementations may generate additional types of content, such as audio, video (e.g., a movie), and/or three-dimensional augmented or virtual reality content. For example, consider a user that wants to generate a song using a generative model. The user could be provided with tag groups relating to the key that the song is in, lyrics for the song, style of the song, etc. As one example, the user could start by generating a song in the key of A with a guitar solo in the style of one artist, then could revise the generated song to be in the key of E with a guitar solo in the style of another artist.

In the case of three-dimensional content, users could be presented with virtual or augmented reality representations of tags and/or tag values. The generated content could also be in the form of three-dimensional augmented or virtual reality content. For instance, consider a user wearing a virtual reality headset that wishes to create a virtual living room. The user could be guided to create furniture and decorations for the room. A color slider could be provided where the user could manipulate hue, brightness, opacity, etc., of virtual objects in the living room. The user could select areas or objects in the living room to modify on an individual basis, or could regenerate the entire living room based on selected tags. The user could also use speech or gesture to specify their intent.

Furthermore, in some implementations, 2D or 3D images, 2D or 3D video, and/or audio (including directional audio) can be employed directly as intent tags. For instance, consider a user that wishes to generate an image of a dog in the style of a particular artist. The user could manually enter an intent tag with the term “dog,” and select an image of a painting by that artist as a style intent tag. Then, an image of a dog could be generated in the style of that artist. Similarly, video and/or audio items can be employed as intent tags to condition content generation of new content items that are stylistically similar to those video and/or audio items.

### Technical Effect

As noted previously, generative machine learning has not been widely integrated into everyday computing devices. Thus, rudimentary human-computer interaction techniques tend to predominate, e.g., by having users manually enter prompts to a generative machine learning model to request content generation. In the disclosed techniques, various user interfaces are employed to guide users to specify their intents via intent tags. The intent tags can be grouped according to different aspects of content generation, e.g., using the tag steering groups as indicated above.

In this manner, users can specify their intent for different aspects of content generation in a flexible, interactive manner. The users do not necessarily need to manually draft prompts to refine content generation. Instead, the users can simply select different intent tags and/or different values for the intent tags, and the disclosed techniques can automatically prompt a generative machine learning model to generate or revise content based on the user's selections.

In addition, while most graphical user interfaces employ fixed, preprogrammed values for graphical user interface elements, the disclosed techniques can dynamically change the user interface elements over time based on user inputs. For instance, the disclosed techniques can dynamically suggest intent tags for the user, and the suggested intent tags can change over time based on previous user selections. In addition, menus or other graphical interface elements are not necessarily fixed programmatically, but rather can be populated with values suggested by generative machine learning models according to user context.

Thus, the disclosed techniques can improve human-computer interaction by reducing the amount of input that users need to provide to a generative model. Users do not necessarily need to precisely specify their intents to a generative model in a prompt. Rather, users can iteratively specify their intents via intent tags, review the content generated by a generative model, and then adjust/revise their specified intents to continue guiding the creation of content.

### Device Implementations

As noted above with respect to FIG. 9, system 900 includes several devices, including a client device 910, a server 920, a server 930, and a server 940. As also noted, not all device implementations can be illustrated, and other device implementations should be apparent to the skilled artisan from the description above and below.

The term “device”, “computer,” “computing device,” “client device,” and or “server device” as used herein can mean any type of device that has some amount of hardware processing capability and/or hardware storage/memory capability. Processing capability can be provided by one or more hardware processors (e.g., hardware processing units/cores) that can execute computer-readable instructions to provide functionality. Computer-readable instructions and/or data can be stored on storage, such as storage/memory and or the datastore and, when executed, can cause a processor to perform acts. The term “system” as used herein can refer to a single device, multiple devices, etc.

Storage resources can be internal or external to the respective devices with which they are associated. The storage resources can include any one or more of volatile or non-volatile memory, hard drives, solid state drives, flash storage devices, and/or optical storage devices (e.g., CDs, DVDs, etc.), among others. As used herein, the terms “computer-readable media” and “computer-readable medium” can include signals. In contrast, the terms “computer-readable storage media” and “computer-readable storage medium” excludes signals. Computer-readable storage media includes “computer-readable storage devices.” Examples of computer-readable storage devices include volatile storage media, such as RAM, and non-volatile storage media, such as hard drives, optical discs, solid state drives, flash memory, etc.

In some cases, the devices are configured with a general-purpose hardware processor and storage resources. Processors and storage can be implemented as separate components or integrated together as in computational RAM. In other cases, a device can include a system on a chip (SOC) type design. In SOC design implementations, functionality provided by the device can be integrated on a single SOC or multiple coupled SOCs. One or more associated processors can be configured to coordinate with shared resources, such as memory, storage, etc., and/or one or more dedicated resources, such as hardware blocks configured to perform certain specific functionality. Thus, the term “processor,” “hardware processor” or “hardware processing unit” as used herein can also refer to central processing units (CPUs), graphical processing units (GPUs), neural processing units (NPUs), controllers, microcontrollers, processor cores, or other types of processing devices suitable for implementation both in conventional computing architectures as well as SOC designs.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In some configurations, any of the modules/code discussed herein can be implemented in software, hardware, and/or firmware. In any case, the modules/code can be provided during manufacture of the device or by an intermediary that prepares the device for sale to the end user. In other instances, the end user may install these modules/code later, such as by downloading executable code and installing the executable code on the corresponding device.

Also note that devices generally can have input and/or output functionality. For example, computing devices can have various input mechanisms such as keyboards, mice, touchpads, voice recognition, gesture recognition (e.g., using depth cameras such as stereoscopic or time-of-flight camera systems, infrared camera systems, RGB camera systems or using accelerometers/gyroscopes, facial recognition, etc.), microphones, etc. Devices can also have various output mechanisms such as printers, monitors, speakers, etc.

Also note that the devices described herein can function in a stand-alone or cooperative manner to implement the described techniques. For example, the methods and functionality described herein can be performed on a single computing device and/or distributed across multiple computing devices that communicate over network(s) 950. Without limitation, network(s) 950 can include one or more local area networks (LANs), wide area networks (WANs), the Internet, and the like.

### Additional Examples

Various examples are described above. Additional examples are described below. One example includes a computer-implemented method comprising receiving user input relating to a content creation task involving generation of content including one or more content items, based at least on the user input, prompting a generative machine learning model to determine one or more predicted or suggested concept tags for the content creation task, outputting the one or more predicted or suggested concept tags on a user interface, receiving a selection of a selected concept tag from the one or more predicted or suggested concept tags via the user interface, the selected concept tag being associated with a selected property having multiple possible values, receiving user input designating a particular value for the selected property associated with the selected concept tag, prompting the generative machine learning model to generate a particular content item based at least on the particular value for the selected property, and outputting the particular content item generated by the generative machine learning model via the user interface.

Another example can include any of the above and/or below examples where the content is a slide deck and the particular content item is at least one slide of the slide deck.

Another example can include any of the above and/or below examples where the generated content item is an outline having content for multiple slides of a slide deck.

Another example can include any of the above and/or below examples where the user input is a narrative describing the content to be generated.

Another example can include any of the above and/or below examples where the method further comprises, based at least on the selected concept tag, prompting the generative machine learning model to determine an additional predicted or suggested concept tag for the content creation task and modifying the particular content item or generating a new content item with the generative machine learning model based at least on another particular value, selected by the user, for the additional predicted or suggested concept tag.

Another example can include any of the above and/or below examples where the user interface includes a selection area, the one or more predicted or suggested content tags are initially displayed outside the selection area, and the selection of the predicted or selected concept tag involves dragging the selected concept tag into the selection area.

Another example can include any of the above and/or below examples where the selection area is circular.

Another example can include any of the above and/or below examples where the method further comprises outputting the multiple possible values for the selected property in a menu adjacent to the selected concept tag.

Another example can include any of the above and/or below examples where the method further comprises prompting the generative machine learning model to predict or suggest the multiple possible values for the selected content tag and populating the menu with the multiple possible values predicted or suggested by the generative machine learning model.

Another example can include any of the above and/or below examples where the method further comprises receiving user input requesting to manually create a new concept tag and creating the new concept tag in response to the user input.

Another example can include any of the above and/or below examples where the method further comprises receiving user input designating a reference tag, the reference tag identifying an external document and prompting the generative machine learning model to generate the particular content item based at least on the external document.

Another example can include any of the above and/or below examples where the method further comprises receiving a user selection of a selected portion of the external document and prompting the generative machine learning model to generate the particular content item based at least on the selected portion of the external document.

Another example can include any of the above and/or below examples where the method further comprises prompting the generative machine learning model to predict or suggest one or more images for the content creation task, receiving a user selection of a predicted or suggested image, and including the predicted or suggested image in the particular content item.

Another example can include any of the above and/or below examples where the method further comprises displaying a moveable user interface element for selecting the particular value from a range and receiving the user input designating the particular value via the moveable user interface element.

Another example can include any of the above and/or below examples where the user input identifies an image that the user wishes to modify.

Another example can include any of the above and/or below examples where the one or more predicted or suggested concept tags can be output by a vision language model by analyzing the image.

Another example includes a system comprising a processor and a storage medium storing instructions which, when executed by the processor, cause the system to receive user input relating to a content creation task involving generation of content including one or more content items, based at least on the user input, prompt a generative machine learning model to determine one or more predicted or predicted or suggested concept tags for the content creation task, output the one or more predicted or suggested concept tags on a user interface, receive a selection of a selected concept tag from the one or more predicted or suggested concept tags via the user interface, the selected concept tag being associated with a selected property having multiple possible values, receive user input designating a particular value for the selected property associated with the selected concept tag, prompt the generative machine learning model to generate a particular content item based at least on the particular value for the selected property, and output the particular content item generated by the generative machine learning model via the user interface.

Another example can include any of the above and/or below examples where the particular content item comprises text generated by the generative machine learning model.

Another example can include any of the above and/or below examples where the particular content item comprises at least one of a static image, a video, or audio generated by the generative machine learning model.

Another example includes a computer-readable storage medium storing instructions which, when executed by a processing device, cause the processing device to perform acts comprising receiving user input relating to a content creation task involving generation of content including one or more content items, based at least on the user input, prompting a generative machine learning model to determine one or more predicted or suggested concept tags for the content creation task, outputting the one or more predicted or suggested concept tags on a user interface, receiving a selection of a selected concept tag from the one or more predicted or suggested concept tags via the user interface, the selected concept tag being associated with a selected property having multiple possible values, receiving user input designating a particular value for the selected property associated with the selected concept tag, prompting the generative machine learning model to generate a particular content item based at least on the particular value for the selected property, and outputting the particular content item generated by the generative machine learning model via the user interface.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other features and acts that would be recognized by one skilled in the art are intended to be within the scope of the claims.

1. A computer-implemented method comprising:
receiving user input relating to a content creation task involving generation of content including one or more content items;
based at least on the user input, prompting a generative machine learning model to determine one or more suggested concept tags for the content creation task;
outputting the one or more suggested concept tags on a user interface;
receiving a selection of a selected concept tag from the one or more suggested concept tags via the user interface, the selected concept tag being associated with a selected property having multiple possible values;
receiving user input designating a particular value for the selected property associated with the selected concept tag;
prompting the generative machine learning model to generate a particular content item based at least on the particular value for the selected property; and
outputting the particular content item generated by the generative machine learning model via the user interface.

2. The computer-implemented method of claim 1, wherein the content is a slide deck and the particular content item is at least one slide of the slide deck.

3. The computer-implemented method of claim 1, wherein the generated content item is an outline having content for multiple slides of a slide deck.

4. The computer-implemented method of claim 1, wherein the user input is a narrative describing the content to be generated.

5. The computer-implemented method of claim 4, further comprising:
based at least on the selected concept tag, prompting the generative machine learning model to determine an additional suggested concept tag for the content creation task; and
modifying the particular content item or generating a new content item with the generative machine learning model based at least on another particular value, selected by the user, for the additional suggested concept tag.

6. The computer-implemented method of claim 1, wherein the user interface includes a selection area, the one or more suggested content tags are initially displayed outside the selection area, and the selection of the selected concept tag involves dragging the selected concept tag into the selection area.

7. The computer-implemented method of claim 6, the selection area being circular.

8. The computer-implemented method of claim 6, further comprising:
outputting the multiple possible values for the selected property in a menu adjacent to the selected concept tag.

9. The computer-implemented method of claim 8, further comprising:
prompting the generative machine learning model to suggest the multiple possible values for the selected content tag; and
populating the menu with the multiple possible values suggested by the generative machine learning model.

10. The computer-implemented method of claim 1, further comprising:
receiving user input requesting to manually create a new concept tag; and
creating the new concept tag in response to the user input.

11. The computer-implemented method of claim 1, further comprising:
receiving user input designating a reference tag, the reference tag identifying an external document; and
prompting the generative machine learning model to generate the particular content item based at least on the external document.

12. The computer-implemented method of claim 11, further comprising:
receiving a user selection of a selected portion of the external document; and
prompting the generative machine learning model to generate the particular content item based at least on the selected portion of the external document.

13. The computer-implemented method of claim 1, further comprising:
prompting the generative machine learning model to suggest one or more images for the content creation task;
receiving a user selection of a suggested image; and
including the suggested image in the particular content item.

14. The computer-implemented method of claim 1, further comprising:
displaying a moveable user interface element for selecting the particular value from a range; and
receiving the user input designating the particular value via the moveable user interface element.

15. The computer-implemented method of claim 1, the user input identifying an image that the user wishes to modify.

16. The computer-implemented method of claim 15, the one or more suggested concept tags being output by a vision language model by analyzing the image.

17. A system comprising:
a processor; and
a storage medium storing instructions which, when executed by the processor, cause the system to:
receive user input relating to a content creation task involving generation of content including one or more content items;
based at least on the user input, prompt a generative machine learning model to determine one or more suggested concept tags for the content creation task;
output the one or more suggested concept tags on a user interface;
receive a selection of a selected concept tag from the one or more suggested concept tags via the user interface, the selected concept tag being associated with a selected property having multiple possible values;
receive user input designating a particular value for the selected property associated with the selected concept tag;
prompt the generative machine learning model to generate a particular content item based at least on the particular value for the selected property; and
output the particular content item generated by the generative machine learning model via the user interface.

18. The system of claim 17, wherein the particular content item comprises text generated by the generative machine learning model.

19. The system of claim 17, wherein the particular content item comprises at least one of a static image, a video, or audio generated by the generative machine learning model.

20. A computer-readable storage medium storing instructions which, when executed by a processing device, cause the processing device to perform acts comprising:
receiving user input relating to a content creation task involving generation of content including one or more content items;
based at least on the user input, prompting a generative machine learning model to determine one or more suggested concept tags for the content creation task;
outputting the one or more suggested concept tags on a user interface;
receiving a selection of a selected concept tag from the one or more suggested concept tags via the user interface, the selected concept tag being associated with a selected property having multiple possible values;
receiving user input designating a particular value for the selected property associated with the selected concept tag;
prompting the generative machine learning model to generate a particular content item based at least on the particular value for the selected property; and
outputting the particular content item generated by the generative machine learning model via the user interface.
